(19) United States
(12) Patent Application Publication
(10) Pub. No.: US 2014/0197353 A1
(43) Pub. Date: Jul. 17, 2014

(54) GRAPHENE/CERAMIC NANOCOMPOSITE POWDER AND A PRODUCTION METHOD THEREFOR

(71) Applicant: KOREA ADVANCED INSTITUTE OF SCEINCE AND TECHNOLOGY, Daejeon (KR)

(72) Inventors: Soonhyung Hong, Daejeon (KR); Min Young Koo, Daejeon (KR); Jaewon Hwang, Daejeon (KR); Bin Lee, Wonju-si (KR)

(73) Assignee: KOREA ADVANCED INSTITUTE OF SCEINCE AND TECHNOLOGY, Daejeon (KR)

(21) Appl. No.: 14/161,292

(22) Filed: Jan. 22, 2014

Related U.S. Application Data
(63) Continuation of application No. PCT/KR2012/003913, filed on May 17, 2012.

(30) Foreign Application Priority Data
Jul. 29, 2011 (KR) 1020110076119
Feb. 22, 2012 (KR) 1020120018179

(51) Int. Cl. C04B 35/74

(52) U.S. Cl. CPC C04B 35/74
USPC 252/71; 264/646

(57) ABSTRACT

The embodiments described herein pertain generally to graphene/ceramic nanocomposite powder including a matrix ceramic; and graphene dispersed in the matrix ceramic and a preparation method thereof, and a graphene/ceramic nanocomposite material including the graphene/ceramic nanocomposite powder and a preparation method thereof.

### CROSS-REFERENCE TO RELATED APPLICATION

This application is a continuation of International Application No. PCT/KR2012/003913 filed on May 17, 2012, claiming the priority based on Korean Patent Application No. 10-2011-0076119 filed on Jul. 29, 2011, and No. 10-2012-0018179 filed on Feb. 22, 2012, the contents of all of which are incorporated herein by reference in their entirety.

### TECHNICAL FIELD

The embodiments described herein pertain generally to graphene/ceramic nanocomposite powder and a preparation method thereof, and a graphene/ceramic nanocomposite material including the graphene/ceramic nanocomposite powder and a preparation method thereof.

### BACKGROUND

Ceramic is a chemically stable material having a strength and a high melting point. Further, ceramic has electromagnetically, optically, and mechanically remarkable properties, and, thus, has been used in various fields such as various elements of electronic devices, a substrate, a capacitor, a sensor, an igniter of an integrated circuit, a nozzle of a space shuttle, and the like.

In recent years, there have been made many studies on improvement of mechanical and electrical properties of a ceramic element used in various fields. A representative example is preparation of ceramic nanopowder by combining ceramic with a nanotechnology. In addition to the existing properties of ceramic, nanopowder exhibits a new property caused by a surface effect or an interaction between particles as sizes of ceramic particles are reduced, so that applications thereof in various fields have been expected. In this regard, Korean Patent No. 10-0590213 describes a method for fabricating carbon nanotube reinforced ceramic nanocomposites by a sol-gel process.

There has also been made studies on addition of a new function to such ceramic nanopowder while maintaining the existing properties of conventional ceramic powder or improvement of mechanical/electrical/thermal properties of the conventional ceramic powder. In particular, a composite powder material, which improves the existing mechanical and electrical properties of ceramic powder by dispersing an inorganic material, has increasingly drawn attention.

In recent years, graphene as a highly dispersed atom-layer of hexagonal arrayed carbon atoms has attracted the interest of those seeking to fabricate new composite materials for molecular electronics due to its high conductivity and good mechanical properties. The combination of high electrical conductivity, good mechanical properties, high surface area, and low manufacturing cost make graphene an ideal candidate material for electrochemical applications. Assuming an active surface area of 2600 m²/g and typical capacitance of 10 μF/m² for carbon materials, graphene has a potential to reach 260 F/g in theoretical specific capacity. However, this high capacity has not been reached because it has proven difficult to access all the surface area and completely disperse graphene sheets. Graphene is generally described as a one-atom-thick planar sheet of sp²-bonded carbon atoms that are densely packed in a honeycomb crystal lattice. A carbon-carbon bond length in graphene is approximately 0.142 nm. Graphene is the basic structural element of some carbon allotropes including graphite, carbon nanotubes and fullerenes. Graphene exhibits unique properties, such as a very high strength and a very high conductivity.

Graphene has been produced by a variety of techniques. By way of example, graphene is produced by the chemical reduction of graphene oxide, as shown in Gomez-Navarro, C.; Weitz, R. T.; Bittner, A. M.; Scolari, M.; Mews, A.; Burghard, M.; Kern, K. “Electronic Transport Properties of Individual Chemically Reduced Graphene Oxide Sheets”, Nano Lett. 2007, 7, 3499-3503, and Si, Y.; Samulski, E. T. “Synthesis of Water Soluble Graphene”, Nano Lett. 2008, 8, 1679-1682. While the resultant product shown in the forgoing methods is generally described as graphene, it is clear from the specific capacity of these materials that complete reduction is not achieved, because the resultant product does not approach the theoretical specific capacity of neat graphene. Accordingly, at least a portion of the graphene is not reduced, and the resultant product contains at least some graphene oxide. The term “graphene” as used herein should be understood to encompass materials such as these containing both graphene and small amounts of graphene oxide.

However, development of an easy and economical process for improving properties of various materials such as ceramic with graphene has been still demanded.

### SUMMARY

In view of the foregoing, the present disclosure provides graphene/ceramic nanocomposite powder including a matrix ceramic and graphene dispersed in the matrix ceramic, and a preparation method thereof.

The present disclosure also provides a graphene/ceramic nanocomposite material including the graphene/ceramic nanocomposite powder, and a preparation method thereof.

However, problems to be solved by the present disclosure are not limited to the above-described problems. Although not described herein, other problems to be solved by the present disclosure can be clearly understood by those skilled in the art from the following descriptions.

In accordance with a first aspect of the present disclosure, graphene/ceramic nanocomposite powder may include a matrix ceramic and graphene dispersed in the matrix ceramic.

In accordance with a second aspect of the present disclosure, a graphene/ceramic nanocomposite material may include a sintered material of the graphene/ceramic nanocomposite powder according to the first aspect.

In accordance with a third aspect of the present disclosure, a preparation method of graphene/ceramic nanocomposite powder may include the following steps: (a) dispersing graphene oxide in a solvent; (b) introducing a metal salt which can be converted into a matrix ceramic, into the solvent in which the graphene oxide is dispersed to obtain a reaction mixture; and (c) performing a heat treatment of the reaction mixture to reduce the graphene oxide to calcine the metal salt to form graphene/ceramic nanocomposite powder including the graphene dispersed in the matrix ceramic.

In accordance with a fourth aspect of the present disclosure, a preparation method of a graphene/ceramic nanocomposite material may include sintering the graphene/ceramic nanocomposite powder prepared according to the method of the third aspect at a temperature in a range of from about 50% to about 80% of the melting point of the matrix ceramic to form a bulk material.

In accordance with the present disclosure, in the graphene/ceramic nanocomposite powder, the graphene is interposed between the ceramic particles of the matrix ceramic and bonded to the ceramic particle, so that the graphene is uniformly dispersed in the matrix ceramic. Thus, it is possible to improve mechanical, electrical, and/or thermal properties of the matrix ceramic.

Accordingly, in accordance with the the present disclosure, it is possible to easily prepare the graphene/ceramic nanocomposite material including the graphene/ceramic nanocomposite powder reinforced in mechanical, electrical, or thermal properties and a sintered material of the graphene/ceramic nanocomposite powder by a simple process.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic diagram illustrating a structure of graphene/ceramic nanocomposite powder in accordance with an example embodiment of the present disclosure.

FIG. 2 is a flow chart for explaining a preparation method of graphene/ceramic nanocomposite powder in accordance with an example embodiment of the present disclosure.

FIG. 3A and FIG. 3B are scanning electron microscopic (SEM) images of graphene/ceramic nanocomposite powder in which graphene is not dispersed and graphene/ceramic nanocomposite powder in which graphene is dispersed in accordance with an example of the present disclosure, respectively.

FIG. 4 is an X-ray diffraction (XRD) spectrum of graphene/ceramic nanocomposite powder in accordance with an example of the present disclosure.

FIG. 5 is an XRD spectrum of graphene/copper oxide nanocomposite powder in accordance with an example of the present disclosure.

FIG. 6 is a SEM image of a microstructure of a graphene/alumina nanocomposite material in accordance with an example of the present disclosure.

FIG. 7A and FIG. 7B are SEM images of 1 vol % graphene/alumina nanocomposite powder and 5 vol % graphene/alumina nanocomposite powder, respectively, prepared in accordance with an example of the present disclosure.

FIG. 8 shows a flexural strength of pure alumina (Al₂O₃), a flexural strength of 1 vol % carbon nanotube/alumina (CNT/Al₂O₃) nanocomposite material, and a flexural strength of 1 vol % graphene/alumina (Al₂O₃) nanocomposite material prepared in accordance with an example of the present disclosure.

FIG. 9 shows a thermal conductivity of pure alumina and a thermal conductivity of 1 vol % graphene/alumina nanocomposite material prepared in accordance with an example of the present disclosure.

### DETAILED DESCRIPTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole of the present disclosure.

Through the whole of the present disclosure, the term “comprises or includes” and/or “comprising or including” used in the document means that one or more other components, steps, operation and/or existence or addition of elements are not excluded in addition to the described components, steps, operation and/or elements unless context dictates otherwise.

The term “about or approximately” or “substantially” are intended to have meanings close to numerical values or ranges specified with an allowable error and intended to prevent accurate or absolute numerical values disclosed for understanding of the present disclosure from being illegally or unfairly used by any unconscionable third party.

Through the whole of the present disclosure, the term “step of” does not mean “step for”. Through the whole of the present disclosure, the term “on” that is used to designate a position of one element with respect to another element includes both a case that the one element is adjacent to the another element and a case that any other element exists between these two elements.

Through the whole of the present disclosure, the term “combination of” included in Markush type description means mixture or combination of one or more components, steps, operations and/or elements selected from a group consisting of components, steps, operation and/or elements described in Markush type and thereby means that the disclosure includes one or more components, steps, operations and/or elements selected from the Markush group.

Through the whole of the present disclosure, a phrase in the form “A and/or B” means “A or B, or A and B”.

Through the whole of the present disclosure, the term “graphene” refers to a material in the form of a monolayered or multilayered sheet forming a polycyclic aromatic molecule with multiple carbon atoms covalently bonded to each other. The covalently bonded carbon atoms can form, for example, a six-member ring, a five-member ring, or a seven-member ring, as a repeating unit.

Through the whole of the present disclosure, the term “ceramic” refers to a non-metallic inorganic solid prepared by heating and cooling. A ceramic material may have a crystalline structure or a partially crystalline structure, or an amorphous structure, but ceramic is generally crystalline and may be limited to an organic crystalline material.

Through the whole of the present disclosure, the term “graphene/ceramic” composite powder refers to powder in which the ceramic serves as a matrix ceramic and graphene is dispersed and distributed in the matrix ceramic. The term “matrix ceramic” is used as the collective name for various kinds of ceramic functioning as a matrix of powder.

Through the whole of the present disclosure, the term “graphene/ceramic nanocomposite powder” refers to nano-sized composite powder in which the ceramic serves as a matrix ceramic and graphene is dispersed and distributed in the matrix ceramic. By way of example, the term “graphene/alumina nanocomposite powder” refers to nano-sized composite powder in which alumina serves as a matrix ceramic and graphene is dispersed and distributed in the matrix ceramic. The term “nano-sized” refers to a material property of having a size, a length, or a width of about 10 μm or less.

In accordance with a first aspect of the present disclosure, graphene/ceramic nanocomposite powder may include a matrix ceramic and graphene dispersed in the matrix ceramic. The graphene is uniformly dispersed in the matrix ceramic, and improves mechanical, electrical, or thermal properties of the matrix ceramic.

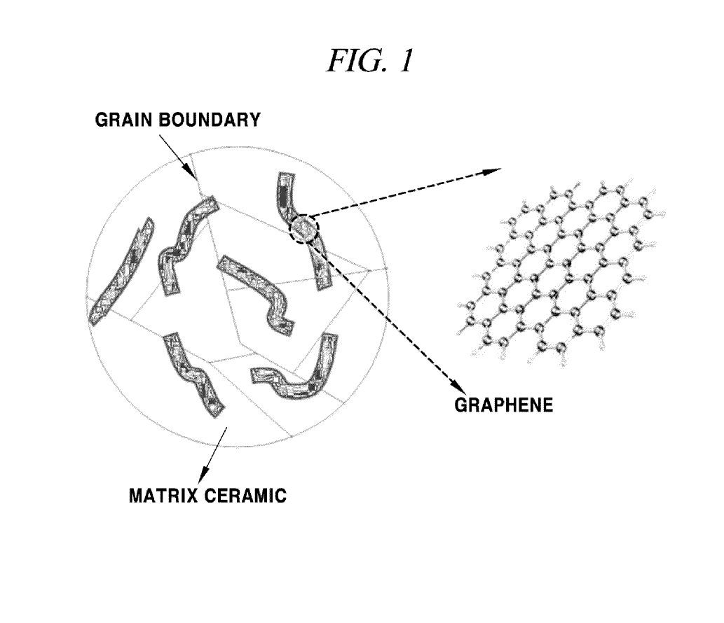

FIG. 1 is a schematic diagram illustrating a structure of graphene/ceramic nanocomposite powder in accordance with an example embodiment of the present disclosure.

Referring to FIG. 1, in the graphene/ceramic nanocomposite powder in accordance with the example embodiment of the present disclosure, the graphene may be interposed between ceramic particles of the matrix ceramic to be uniformly dispersed with being bonded to the ceramic particles, but may not be limited thereto. Nanocomposite powder in such a form can improve sinterability of the matrix ceramic powder by suppressing surfaces of the matrix ceramic powder from being covered with the graphene.

The graphene may include a monolayer or multiple layers of carbon atoms, and may be a film having a thickness of, for example, about 100 nm or less, but may not be limited thereto.

In accordance with an example embodiment of the present disclosure, the matrix ceramic may include a member selected from the group consisting of an oxide, a carbide, a nitride, a boride, and combinations thereof, but may not be limited thereto. The matrix ceramic may be an oxide, and may include one or more selected from the group consisting of, for example, Al₂O₃, SiO₂, TiO₂, ZrO₂, Ta₂O₅, MgO, BeO, and combinations thereof, but may not be limited thereto. The carbide may include, for example, SiC, TiC, ZrC, HfC, VC, NbC, TaC, Mo₂C, or WC, but may not be limited thereto. The nitride may include, for example, TiN, ZrN, HfN, VN, NbN, TaN, or AlN, but may not be limited thereto. The boride may include, for example, TiB₂, ZrB₂, HfB₂, VB₂, NbB₂, TaB₂, WB₂, or MoB₂, but may not be limited thereto.

If an amount of graphenes dispersed in the matrix ceramic is excessively more than a predetermined amount, the graphene may undergo structural transformation due to condensation in the graphenes caused by interaction in the graphenes. The structural transformation of the graphenes may be, for example, structural transformation of the graphenes to graphite. In a part of the nanocomposite powder, the structural transformation of the graphenes is considered to inhibit a function of improving the mechanical, electrical, or thermal properties of the matrix ceramic. Therefore, an amount of the graphene dispersed in the matrix ceramic needs to be adequately controlled. Thus, in accordance with an example embodiment of the present disclosure, an amount of the graphene dispersed in the matrix ceramic may be in a range of from more than about 0 vol % to about 50 vol %, or from more than about 0 vol % to about 40 vol %, or from more than about 0 vol % to about 30 vol %, but may not be limited thereto.

In accordance with an example embodiment of the present disclosure, the matrix ceramic may be formed by calcining a metal salt, but may not be limited thereto. A material of the matrix ceramic may include ceramic formed by calcining all metal salts which can be ceramic matrixes after calcination. The material of the matrix ceramic may include ceramic particles. But the present disclosure may not be limited thereto.

In accordance with an example embodiment of the present disclosure, the metal salt may include a salt of a metal selected from the group consisting of Al, Cu, Co, Ni, Sn, Cr, Mg, Zn, Si, Ti, Zr, Hf, V, Nb, Ta, Mo, W, Ag, Pt, Au, Pd, and combinations thereof, but may not be limited thereto.

In accordance with an example embodiment of the present disclosure, the matrix ceramic may employ various kinds of ceramic in the form of powder. A ceramic particle in the matrix ceramic may have a size in a range of from about several nm to about several tens μm or less, for example, from about from about 1 nm to about 10 μm, from about 10 nm to about 10 μm, from about 50 nm to about 10 μm, from about 100 nm to about 10 μm, from about 500 nm to about 10 μm, from about 1 nm to about 5 μm, or from about 1 nm to about 1 μm, but may not be limited thereto.

The graphene is interposed between the ceramic particles of the matrix ceramic and bonded to the ceramic particles and uniformly dispersed, and, thus, it can serve as a reinforcing agent for improving mechanical properties, such as a tensile strength, of the matrix ceramic, and also can improve mechanical, electrical, or thermal properties of the matrix ceramic.

In accordance with a second aspect of the present disclosure, a graphene/ceramic nanocomposite material may include a sintered material of the graphene/ceramic nanocomposite powder according to the first aspect.

As described above, in the graphene/ceramic nanocomposite powder in accordance with an example embodiment of the present disclosure, the graphene may be interposed between the ceramic particles of the matrix ceramic to be uniformly dispersed with being bonded to the ceramic particles, and can improve sinterability, and thermal and electrical properties of the matrix ceramic powder by suppressing surfaces of the matrix ceramic powder from being covered with the graphene. Thus, the graphene/ceramic nanocomposite powder in accordance with an example embodiment of the present disclosure may be sintered at a temperature in a range of from about 50% to about 80% of the melting point of the matrix ceramic to form a bulk material, so that it is possible to easily prepare the graphene/ceramic nanocomposite material in accordance with an example embodiment of the present disclosure.

In accordance with a third aspect of the present disclosure, a preparation method of graphene/ceramic nanocomposite powder may include the following steps: (a) dispersing graphene oxide in a solvent; (b) introducing a metal salt which can be converted into a matrix ceramic, into the solvent in which the graphene oxide is dispersed to obtain a reaction mixture; and (c) performing a heat treatment of the reaction mixture to reduce the graphene oxide to calcine the metal salt to form graphene/ceramic nanocomposite powder including the graphene dispersed in the matrix ceramic.

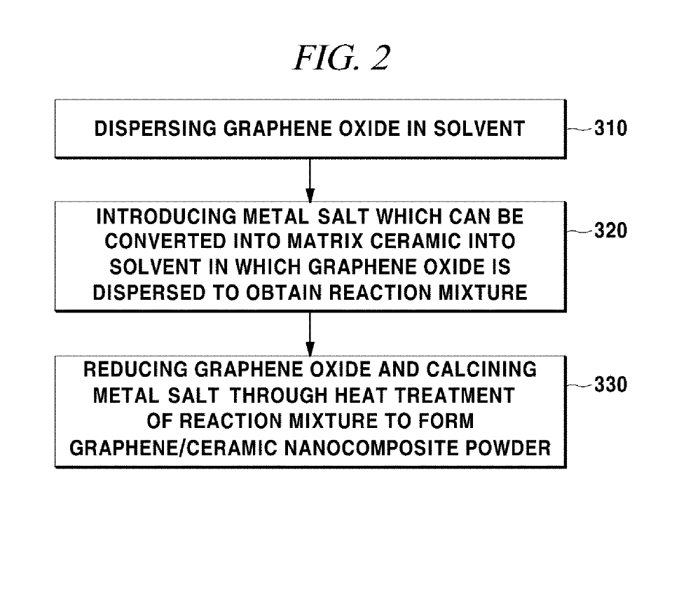

FIG. 2 is a flow chart illustrating a preparation method of graphene/ceramic nanocomposite powder in accordance with an example embodiment of the present disclosure.

Referring to FIG. 2, in block 310, graphene oxide is dispersed in a solvent. The graphene oxide can be separated and obtained from a graphite structure by the publicly-known Hummers process or a modified Hummers process. The publicly-known Hummers process is disclosed in Journal of the American Chemical Society 1958, 80, 1339 by Hummers et al., and a technique disclosed in this article may be incorporated herein by reference in its entirety.

In accordance with an example embodiment of the present disclosure, the solvent may employ any solvent without limitation as long as it can uniformly disperse the graphene oxide, and may include, for example, but not limited to, ethylene glycol. The graphene oxide may be a single sheet oxidized and separated from a carbon multilayered structure of the graphite by the publicly-known Hummers process or the modified Hummers process. The graphene oxide may be uniformly distributed in the solvent by performing a dispersion process, such as an ultrasonic treatment.

In block 320, a metal salt which can be converted into a matrix ceramic, is introduced into the solvent in which the graphene oxide is dispersed, so that a reaction mixture is obtained.

In accordance with an example embodiment of the present disclosure, the matrix ceramic may include an inorganic material selected from the group consisting of an oxide, a carbide, a nitride, a boride, and combinations thereof, but may not be limited thereto. The matrix ceramic may be an oxide, and may include one or more selected from the group consisting of, for example, Al₂O₃, SiO₂, TiO₂, ZrO₂, Ta₂O₅, MgO, BeO, and combinations thereof, but may not be limited thereto. The carbide may include, for example, SiC, TiC, ZrC, HfC, VC, NbC, TaC, Mo₂C, or WC, but may not be limited thereto. The nitride may include, for example, TiN, ZrN, HfN, VN, NbN, TaN, or AlN, but may not be limited thereto. The boride may include, for example, TiB₂, ZrB₂, HfB₂, VB₂, NbB₂, TaB₂, WB₂, or MoB₂, but may not be limited thereto.

In accordance with an example embodiment of the present disclosure, the metal salt may include a salt of a metal selected from the group consisting of aluminum, copper, cobalt, nickel, tin, chromium, magnesium, zinc, and combinations thereof, but may not limited thereto. By way of example, the metal salt may include a salt of a metal selected from the group consisting of Al, Cu, Co, Ni, Sn, Cr, Mg, Zn, Si, Ti, Zr, Hf, V, Nb, Ta, Mo, W, Ag, Pt, Au, Pd, and combinations thereof (for example, a nitrate, a sulfate, a phosphate, a carbonate, a hydroxide, or combinations thereof), but may not be limited thereto. Herein, an amount of the metal salt may be adjusted depending on an amount of the graphene oxide dispersed in the solvent. That is, in order to suppress aggregation of graphene reduced from the graphene oxide in a subsequent process, an amount of the graphene oxide and an amount of the metal salt may be adjusted.

In accordance with an example embodiment of the present disclosure, an amount of the graphene oxide and an amount of the metal salt of the ceramic may be adjusted such that the graphene dispersed in the graphene/ceramic nanocomposite powder as a final product has a volume ratio in a range of from more than about 0 vol % to about 50 vol %, but may not be limited thereto. If the graphene oxide and the metal salt are supplied such that an amount of the graphene has a volume ratio of more than about 50 vol %, the graphene may undergo structural transformation due to condensation in the reduced graphene. The structural transformation of the graphene may be, for example, structural transformation of the graphene to graphite. Such structural transformation may combine with the ceramic particles in the prepared graphene/ceramic nanocomposite powder and inhibit a function of improving the mechanical, electrical, or thermal properties of the matrix ceramic. Thus, for example, an amount of the graphene dispersed in the matrix ceramic may be in a range of from more than about 0 vol % to about 50 vol %, or from more than about 0 vol % to about 40 vol %, or from more than about 0 vol % to about 30 vol %, but may not be limited thereto.

In accordance with an example embodiment of the present disclosure, the graphene oxide and the metal salt of the ceramic may be uniformly mixed with each other by performing an ultrasonic treatment or a magnetic mixing process in the solvent, but may not be limited thereto.

In block 330, graphene/ceramic nanocomposite powder including the graphene, as a reinforcing agent of the matrix ceramic, dispersed between the ceramic particles of the matrix ceramic can be formed by reducing the graphene oxide and calcining the metal salt through a heat treatment of the reaction mixture.

In accordance with an example embodiment of the present disclosure, the heat treatment may be performed in a reducing environment at from about 300° C. to about 1,000° C. in the step (c), but may not be limited thereto. The reducing environment may include a reducing gas such as argon, hydrogen, or nitrogen, but may not be limited thereto.

In accordance with an example embodiment of the present disclosure, the preparation method may further include drying the reaction mixture at a temperature in a range of from about 70° C. to about 100° C. prior to the step (c), but may not be limited thereto. The graphene is rapidly oxidized and disappear in air environment and at a temperature of about 400° C. or more, and, thus, a condition of the drying may be desirably in a range of from about 70° C. to about 100° C. in which water can be sufficiently removed from the solvent for dispersing the graphene. Desirably, a drying time may be in a range of, for example, from about 6 hours to about 12 hours in which sufficient oxygen and air may be supplied to sufficiently remove impurities, i.e. water or an organic solvent, in the above-described temperature range.

In accordance with a fourth aspect of the present disclosure, a preparation method of a graphene/ceramic nanocomposite material may include sintering the graphene/ceramic nanocomposite powder according to the third aspect at a temperature in a range of from about 50% to about 80% of the melting point of the matrix ceramic to form a bulk material. As described above, in the graphene/ceramic nanocomposite powder in accordance with an example embodiment of the present disclosure, the graphene may be interposed between ceramic particles of the matrix ceramic to be uniformly dispersed with being bonded to the ceramic particles. Thus, it is possible to improve sinterability of the matrix ceramic powder by suppressing surfaces of the matrix ceramic powder from being covered with the graphene. Therefore, the graphene/ceramic nanocomposite powder in accordance with an example embodiment of the present disclosure may be sintered at a temperature in a range of, for example, from about 50% to about 80% of the melting point of the matrix ceramic to form a bulk material, so that it is possible to easily prepare the graphene/ceramic nanocomposite material in accordance with an example embodiment of the present disclosure.

Hereinafter, the present disclosure will be explained in detail with reference to the following examples, but the present disclosure may not be limited thereto.

### EXAMPLE

### Example 1

Graphite powder 1 g was slowly added to a container containing 40 mL of concentrated sulfuric acid (H₂SO₄), and then, the container was stirred in a water tank containing ice therein. KMnO₄ 3.5 g was slowly added to the container for 15 minutes, and after a temperature was increased to 35° C., the container was stirred at a speed of 200 to 300 rpm for 2 hours. After stirring, the container was put into the water tank containing ice, and 150 mL to 200 mL of water was added thereto. Then, hydrogen peroxide (H₂O₂) was slowly instilled into the container and reacted until gas bubbles disappeared. The reactant was filtered through a glass filter and washed several times with a 10% hydrochloric acid aqueous solution and dried in a vacuum state for about 3 to 5 days. Graphene oxide powder 70 mg prepared by the above-described process was put into 500 mL of ethanol and underwent an ultrasonication treatment for 2 hours, so that the graphene oxide was uniformly dispersed in distilled water. Then, aluminum nitrate hydrate (Al(NO₃)₃.9H₂O) 30 g was mixed with the prepared graphene oxide-dispersed solution. After the solvent was removed, a calcination process was performed in an argon environment at 350° C. for 5 hours in order to convert the aluminum nitrate hydrate into alumina. During this process, the graphene oxide was reduced to graphene, so that graphene/alumina nanocomposite powder mixed in a molecular level was formed. The graphene/alumina nanocomposite powder was prepared such that the graphene had a volume ratio of 3 vol %.

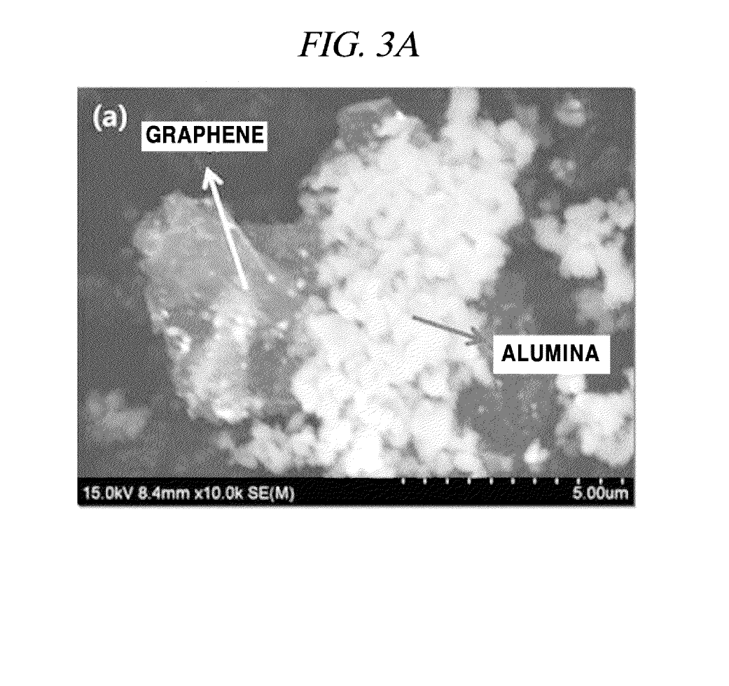

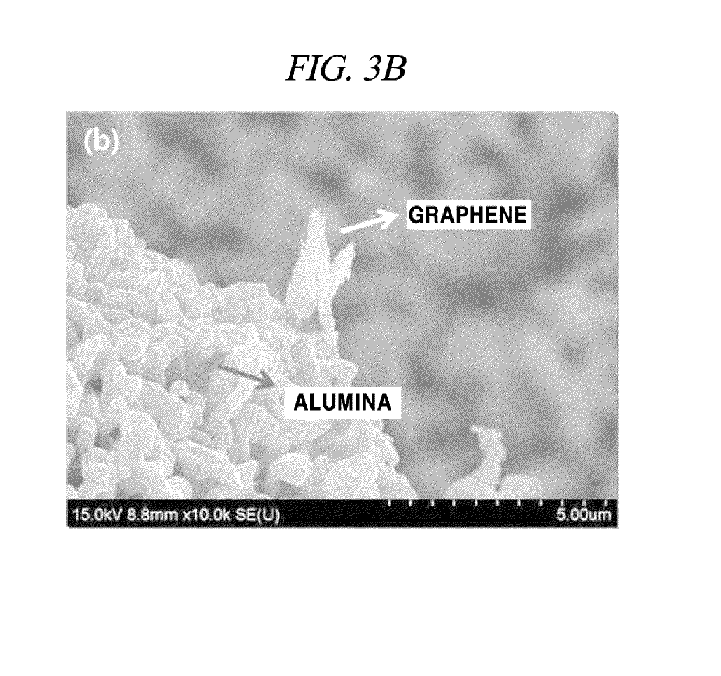

FIG. 3A and FIG. 3B are scanning electron microscopic images of the graphene/alumina ceramic nanocomposite powder in accordance with the present example. To be specific, FIG. 3A is a scanning electron microscopic image of the graphene/alumina nanocomposite powder in which the graphene is not dispersed, and FIG. 3B is a scanning electron microscopic image of the graphene/alumina nanocomposite powder in which the graphene is dispersed in accordance with the present example.

The graphene is interposed between ceramic particles in the alumina matrix ceramic. Since the graphene is dispersed in the matrix ceramic and bonded to the ceramic particles, it can serve as a reinforcing agent for improving mechanical properties, such as a tensile strength, of the alumina matrix ceramic and can also improve thermal or electrical properties of the alumina matrix ceramic. The graphene/ceramic nanocomposite powder illustrated in FIG. 3B contains graphene having a volume ratio of 5 vol %.

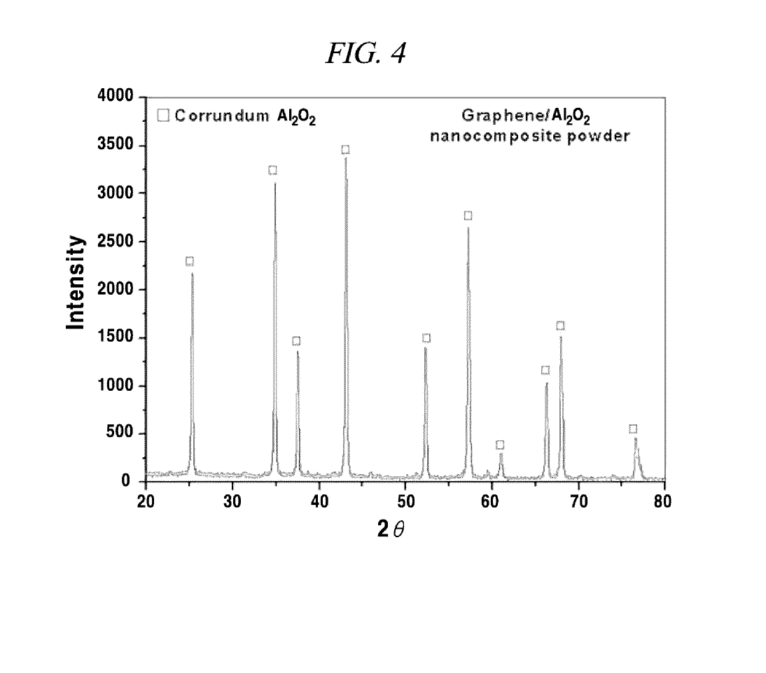

FIG. 4 is an XRD spectrum of the graphene/ceramic nanocomposite powder in accordance with the present example.

### Example 2

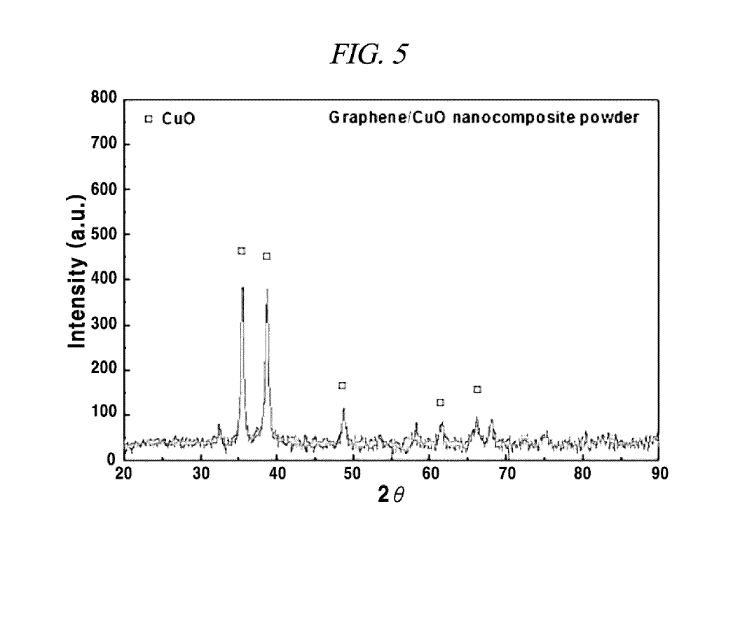

Graphite powder 1 g was slowly added to a container containing 40 mL of concentrated sulfuric acid (H₂SO₄), and then, the container was stirred in a water tank containing ice therein. KMnO₄ 3.5 g was slowly added to the container for 15 minutes, and after a temperature was increased to 35° C., the container was stirred at a speed of 200 to 300 rpm for 2 hours. After stirring, the container was put into the water tank containing ice, and 150 mL to 200 mL of water was added thereto. Then, hydrogen peroxide (H₂O₂) was slowly instilled into the container and reacted until gas bubbles disappeared. The reactant was filtered through a glass filter and washed several times with a 10% hydrochloric acid aqueous solution and dried in a vacuum state for 3 to 5 days. Graphene oxide powder 70 mg prepared by the above-described process was put into about 500 mL of ethanol and underwent an ultrasonication treatment for 2 hours, so that the graphene oxide was uniformly dispersed in distilled water. Then, copper salt (Cu(CH₃COO)₂.H₂O) 30 g was mixed with the prepared graphene oxide-dispersed solution. After the solvent was removed, a calcination process was performed in an argon environment at about 350° C. for about 5 hours in order to convert the copper salt into copper oxide. During this process, the graphene oxide was reduced to graphene, so that graphene/copper oxide nanocomposite powder mixed in a molecular level was formed. The graphene/copper oxide nanocomposite powder was prepared such that the graphene had a volume ratio of 3 vol %. FIG. 5 is an XRD spectrum of the graphene/copper oxide nanocomposite powder in accordance with the present example.

### Example 3

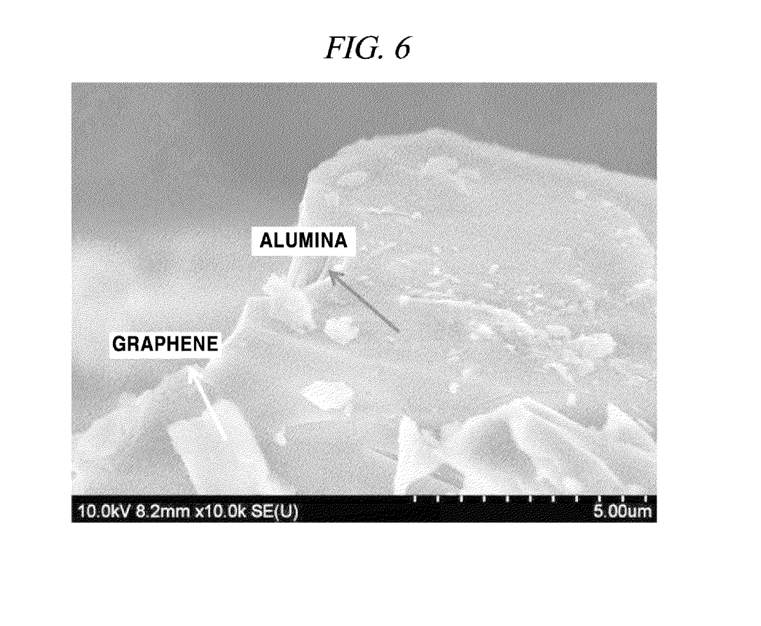

A SPS (Spark Plasma Sintering) process was used to form a graphene/alumina nanocomposite material using the graphene/alumina nanocomposite powder of Example 1. The SPS process was carried out in order to minimize losses of graphene caused by heat since the SPS process was characterized by a rapid increase in temperature, a rapid progress of sintering, and a vacuum environment. In order to perform the sintering process, a carbon mold having a size of 13 pi was prepared. In order to suppress diffusion of carbon of the mold into a material at a high temperature, the mold was coated with BN (Boron Nitride) spray. The sintering process was carried out in a vacuum environment by increasing a temperature up to 1,400° C. at a rate of 100° C. per minute and then maintaining the temperature at 1,400° C. for 10 minutes. A pressure applied to the carbon mold was 50 MPa. After the sintering process was completed, a carbon diffusion layer was removed from a surface of the composite material with sandpaper. The graphene/alumina nanocomposite material contained the graphene having a volume ratio of 5 vol % like the graphene/alumina nanocomposite powder of Example 1. FIG. 6 shows a microstructure of the graphene/alumina nanocomposite material sintered by the SPS process in accordance with the present example.

### Example 4

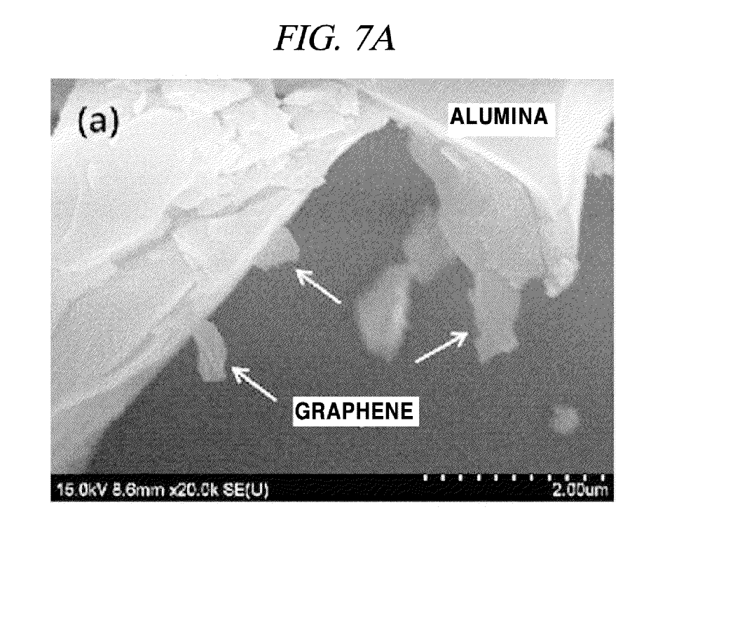

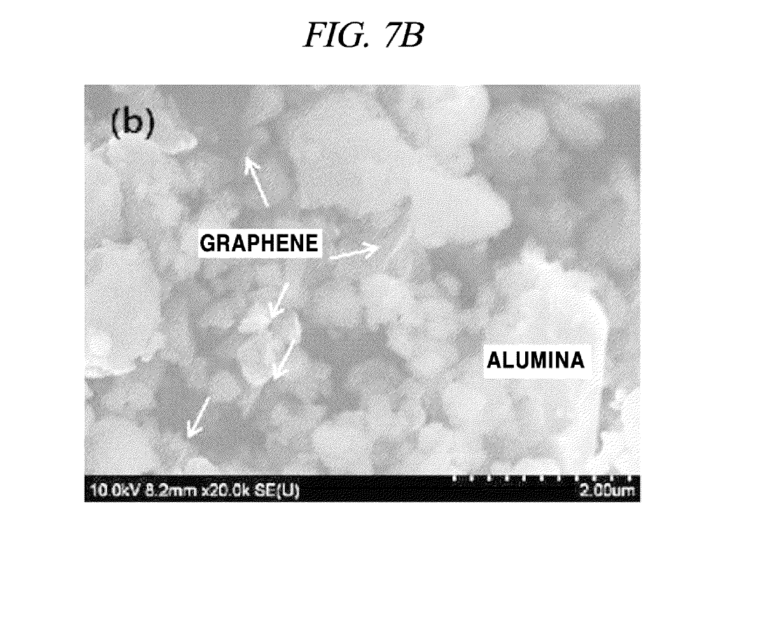

Graphene oxide powers 10 mg and 50 mg were dispersed in a solution of 500 mL containing 3 g of aluminum nitrate hydrate and ethanol. Then, the solvent containing ethanol was removed, so that 1 vol % graphene/alumina nanocomposite powder and 5 vol % graphene/alumina nanocomposite powder were prepared. FIG. 7A and FIG. 7B are SEM images of the 1 vol % graphene/alumina nanocomposite powder and the 5 vol % graphene/alumina nanocomposite powder, respectively, prepared in accordance with the present example.

### Example 5

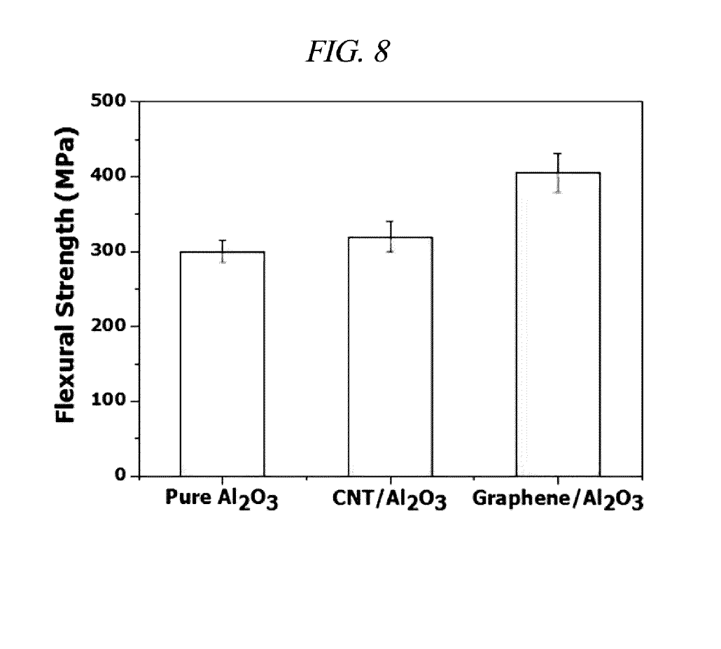

The 1 vol % graphene/alumina nanocomposite powder prepared in accordance with Example 1 was sintered by the SPS process at 1,400° C. for 10 minutes. Then, the sintered composite material was processed into a rectangular parallelepiped of 10 mm×1 mm×1 mm, and then, a 3-point flexural strength was measured. A 3-point flexural strength of the 1 vol % graphene/alumina nanocomposite material was about 405 MPa. Considering a 3-point flexural strength of pure alumina prepared from aluminum nitrate hydrate without graphene by the same method was 300 MPa, it could be seen that the 3-point flexural strength was increased by 30% or more. FIG. 8 shows a flexural strength of pure alumina (Al₂O₃), a flexural strength of 1 vol % carbon nanotube/alumina (CNT/Al₂O₃) nanocomposite material, and a flexural strength of the 1 vol % graphene/alumina (Al₂O₃) nanocomposite material prepared in accordance with the present example.

### Example 6

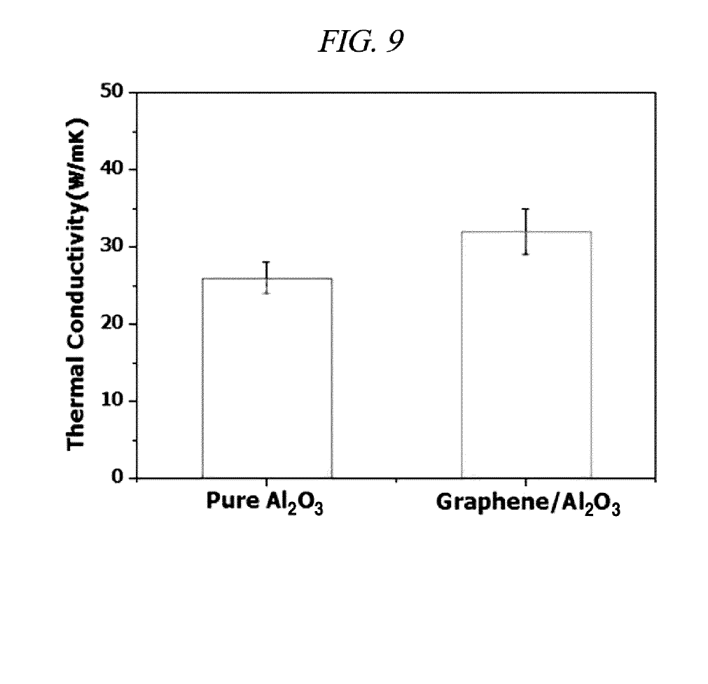

The 1 vol % graphene/alumina nanocomposite powder prepared in accordance with Example 1 was sintered by the SPS process at 1,400° C. for 10 minutes. Then, a thermal conductivity of the sintered composite material was measured. A thermal conductivity of the 1 vol % graphene/alumina nanocomposite material was 32 W/mk. Considering a thermal conductivity of pure alumina prepared from aluminum nitrate hydrate without graphene by the same method was 26 W/mK, it could be seen that the thermal conductivity was increased by 20% or more. FIG. 9 shows a thermal conductivity of pure alumina and a thermal conductivity of the 1 vol % graphene/alumina nanocomposite material prepared in accordance with the present example.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. Graphene/ceramic nanocomposite powder comprising:
a matrix ceramic; and
graphene dispersed in the matrix ceramic.

2. The graphene/ceramic nanocomposite powder of claim 1,
wherein the matrix ceramic includes a member selected from the group consisting of an oxide, a carbide, a nitride, a boride, and combinations thereof.

3. The graphene/ceramic nanocomposite powder of claim 1,
wherein the graphene is interposed between ceramic particles of the matrix ceramic to be uniformly dispersed with being bonded to the ceramic particles.

4. The graphene/ceramic nanocomposite powder of claim 1,
wherein an amount of the graphene dispersed in the matrix ceramic is in a range of from more than about 0 vol % to about 50 vol %.

5. The graphene/ceramic nanocomposite powder of claim 1,
wherein the matrix ceramic includes a ceramic particle having a size in a range of from about 1 nm to about 10 μm.

6. The graphene/ceramic nanocomposite powder of claim 1,
wherein the matrix ceramic is formed by calcining a metal salt.

7. The graphene/ceramic nanocomposite powder of claim 6,
wherein the metal salt includes a salt of a metal selected from the group consisting of Al, Cu, Co, Ni, Sn, Cr, Mg, Zn, Si, Ti, Zr, Hf, V, Nb, Ta, Mo, W, Ag, Pt, Au, Pd, and combinations thereof.

8. A graphene/ceramic nanocomposite material comprising a sintered material of the graphene/ceramic nanocomposite powder according to claim 1.

9. A preparation method of graphene/ceramic nanocomposite powder, comprising:
(a) dispersing graphene oxide in a solvent;
(b) introducing a metal salt which can be converted into a matrix ceramic, into the solvent in which the graphene oxide is dispersed to obtain a reaction mixture; and
(c) performing a heat treatment of the reaction mixture to reduce the graphene oxide to calcine the metal salt to form graphene/ceramic nanocomposite powder including the graphene dispersed in the matrix ceramic.

10. The preparation method of graphene/ceramic nanocomposite powder of claim 9,
wherein an amount of the graphene dispersed is in a range of from more than about 0 vol % to about 50 vol %.

11. The preparation method of graphene/ceramic nanocomposite powder of claim 9,
wherein the metal salt includes a salt of a metal selected from the group consisting of Al, Cu, Co, Ni, Sn, Cr, Mg, Zn, Si, Ti, Zr, Hf, V, Nb, Ta, Mo, W, Ag, Pt, Au, Pd, and combinations thereof.

12. The preparation method of graphene/ceramic nanocomposite powder of claim 9,
wherein the heat treatment is performed in a reducing environment at from about 300° C. to about 1,000° C., in the step (c).

13. The preparation method of graphene/ceramic nanocomposite powder of claim 9, further comprising:
drying the reaction mixture at a temperature in a range of from about 70° C. to about 100° C. prior to the step (c).

14. A preparation method of a graphene/ceramic nanocomposite material, comprising:
sintering the graphene/ceramic nanocomposite powder prepared according to the method of claim 9 at a temperature in a range of from about 50% to about 80% of the melting point of the matrix ceramic to form a bulk material.
